(19) United States
(12) Patent Application Publication
(10) Pub. No.: US 2013/0277628 A1
(43) Pub. Date: Oct. 24, 2013

(54) AUTOMOTIVE JACK CONVERTER AND COOPERATING CASE

(71) Applicant: Thomas Giese, (US)

(72) Inventor: Thomas Giese, (US)

(21) Appl. No.: 13/453,683

(22) Filed: Apr. 23, 2012

(51) Int. Cl. B66F 3/08

(52) U.S. Cl. 254/103

(57) ABSTRACT

A portable and self-contained prime mover arrangement. A base is positioned on a generally horizontal surface and is so stabilized and so balanced so as to be readily insertable under a vehicle requiring lifting off the generally horizontal surface while remaining in full contact with the generally horizontal surface during positioning under, and lifting or lowering, the vehicle. An electric motor is positioned on the base. A gear box is positioned on the base, and is operatively connected to the electric motor. A coupler is positioned on the base, is operatively connected to the gear box, receives, and thereby motorizes, either a conventional and pre-existing mechanical bottle jack or a conventional and pre-existing scissor jack. A handle is replaceably attached to the base, and readily inserts the portable and self-contained prime mover arrangement under the vehicle or removes the portable and self-contained prime mover arrangement from under the vehicle.

### 1. BACKGROUND OF THE INVENTION

A. Field of the Invention

The embodiments of the present invention relate to a prime mover, and more particularly, the embodiments of the present invention relate to a portable and self-contained prime mover arrangement for receiving, and thereby motorizing, a conventional and pre-existing mechanical bottle jack or a conventional pre-existing scissor jack and for being so stabilized and so balanced so as to be readily insertable under a vehicle requiring lifting off a generally horizontal surface while remaining in full contact with the generally horizontal surface during positioning under, and lifting or lowering, the vehicle.

B. Description of the Prior Art

Numerous innovations for motor-driven jacks have been provided in the prior art, which will be described below in chronological order to show advancement in the art, and which are incorporated in their entirety herein by reference thereto. Even though these innovations may be suitable for the specific individual purposes to which they address, nevertheless, they differ from the present invention in that they do not teach a portable and self-contained prime mover arrangement for receiving, and thereby motorizing, a conventional and pre-existing mechanical bottle jack or a conventional pre-existing scissor jack and for being so stabilized and so balanced so as to be readily insertable under a vehicle requiring lifting off a generally horizontal surface while remaining in full contact with the generally horizontal surface during positioning under, and lifting or lowering, the vehicle.

(1) U.S. Pat. No. 1,764,988 to Schwerin.

U.S. Pat. No. 1,764,988—issued to Schwerin on Jun. 17, 1930—teaches a jack including a housing frame forming a base and standard provided with a nut, and a lifting member. A lifting screw that coacts with the nut. A worm-wheel is on the lower portion of the screw. A worm meshes the worm-wheel. An air motor is mounted on the base of the jack directly over the worm, and has a horizontal crank-shaft parallel with the worm. A power-multiplying gearing is between the crank-shaft and the worm shaft. The motor and gearing have a housing joining with the main jack housing. The motor with part of the gearing, on the one hand, and the remainder of the jack, including the worm wheel and worm and the remainder of the gearing, on the other hand, are separable as units on a plane of cleavage cutting the housing between the horizontal shafts. Apparatus rigidly units the units together.

(2) U.S. Pat. No. 2,993,670 to Zollinger.

U.S. Pat. No. 2,993,670—issued to Zollinger on Jul. 25, 1961 in U.S. class 248 and subclass 58—teaches a motor-operated hanger for supporting a load subject to movement within a limited range of movement. The hanger includes a supporting member adapted to be secured to a fixed structure, a movable member movable with regard to the supporting member and adapted to be secured to the load, and a jack connected to the supporting member and to the movable member. The jack when actuated moves the movable member with respect to the supporting member. The hanger further includes a motor, a connecting apparatus connecting the motor to the jack. The motor when turned on actuating the jack through the connecting apparatus. The hanger further includes sensing apparatus for sensing changes on the load and for actuating the motor in response to the changes. The sensing means is located between the jack and the supporting member and has a portion movable with respect to the supporting member with changes in load in a substantially straight line. A portion of the jack engages the movable portion and causes movement thereof with changes in the load. The connecting apparatus connects the motor to the jack and has at least a portion movable with the movement of the movable sensing apparatus portion.

(3) U.S. Pat. No. 4,653,727 to Chang et al.

U.S. Pat. No. 4,653,727—issued to Chang et al. on Mar. 31, 1987 in U.S. class 254 and subclass 1—teaches motor driven scissors jacks for automobiles, and is driven by the electric power source from the cigarette lighting socket of any automobile. Its DC motor is driven through a deceleration gear box for rotating a screw rod clockwise or counter-clockwise in order to provide for the raising of the frames of scissors jacks with automatic raising of vehicles, and for the higher raising and lower collapsing functions, and a more powerful raising capability. It is also provided with one ultimate switch for peak and low bottom points in order to limit its raising and collapsing operation to fixed points, and an automatic stop for safe raising operations and for preventing damage to the motor.

(4) U.S. Pat. No. 5,085,407 to Lonon.

U.S. Pat. No. 5,085,407—issued to Lonon on Feb. 4, 1992 in U.S. class 254 and subclass 103—teaches a motorized jack assemblage for vehicles. This takes the form of a kit containing a motor and reduction gear linkage adapted to be energized from the cigarette lighter or other source of electrical power in the vehicle. The gear linkage is adapted to drive mechanical coupling apparatus that keys into and operates a lift jack, which in one case is part of the standard equipment for the vehicle, and in another case is a jack with a specialized base that is part of the kit.

(5) U.S. Pat. No. 6,685,169 to Shim.

U.S. Pat. No. 6,685,169—issued to Shim on Feb. 3, 2004 in U.S. class 254 and subclass 103—teaches a motor-operated jack for vehicles, which includes a lifting unit that includes a spiral lifting ram having an internal thread limitedly formed at a lower portion of the spiral lifting ram, and a pin held in a horizontal groove formed at the top end of a primary screw. The pin is slightly projected into two longitudinal holes symmetrically formed at the top portion of a secondary screw. There is also a coil spring, a spring cover, and a snap ring sequentially laid on the top of the pin. There is also a support ram having a top support and an external thread, movably fitted in a gap between the secondary screw and the spiral lifting ram while engaging with an internal thread of the spiral lifting ram at the external thread, thus allowing a user to control the moving stroke of the lifting unit as desired.

(6) U.S. Pat. No. 6,695,289 to Mickael.

U.S. Pat. No. 6,695,289—issued to Mickael on Feb. 24, 2004 in U.S. class 254 and subclass 122—teaches a motorized scissor jack including upper and lower limit switches. The motor is connected with a drive assembly that extends and retracts the jack through a displacement screw. The motor has two speeds. The jack is connectable to a vehicular or standard alternating current power source. The upper and lower limit switches limit the extension and retraction of the jack to defined peak and bottom points. The jack is configured for operation in inclement weather.

(7) United States Patent Application Publication Number 2005/0109996 to Razzaghi.

United States Patent Application Publication Number 2005/0109996—published to Razzaghi on May 26, 2005 in U.S. class 254 and subclass 126—teaches an apparatus and method for an electric jack. An electrically powered jack is provided for at least partially raising and lowering an automobile off a ground surface. The electric jack may be utilized in conjunction with a conventional portable car jack. The jack includes a power drill, a rod, and a plurality of jack adapters. Each jack adapter is specifically designed to attach to a particular type of car jack, thus providing an apparatus that may be utilized with an assortment of car jacks.

(8) U.S. Pat. No. 6,910,677 to Miller et al.

U.S. Pat. No. 6,910,677—issued to Miller et al. on Jun. 28, 2005 in U.S. class 254 and subclass 126—teaches a battery driven reversible motor and speed reduction gear assembly coupled to a worm-screw scissor jack, all mounted on a flat, stable platform (base plate) for use in raising and lowering the corner of a vehicle. The device can be powered from a rechargeable battery pack or from the vehicle's battery. A controller unit extended by way of a cable is used to raise and lower the vehicle while the user stands out-of-the-way in safe location. The device also has a light for illuminating the work area for nighttime application. In use, the lift plate on top of the scissor-jack is placed under the frame or axle of the vehicle close to the flat tire and the power switch is turned ON. The user then walks away from the vehicle, with the controller unit in his/her hand, to a safe distance. The UP button on the controller unit is pressed to enable the motor and gear drive so that the drive shaft, which is coupled to the worn-screw of the scissor-jack, turns slowly lifting the corner of the vehicle up until the flat tire is off the ground. This process is reversed to lower the vehicle once the flat tire has been changed.

(9) United States Patent Application Publication Number 2007/0256526 to Razzaghi.

United States Patent Application Publication Number 2007/0256526 published to Razzaghi on Nov. 8, 2007 in U.S. class 81 and subclass 176.15 teaches an apparatus and method for an electric jack. An electrically powered jack is provided for at least partially raising and lowering an automobile off a ground surface. The apparatus may be utilized in conjunction with a conventional portable car jack. The apparatus includes a power drill, a rod, and a plurality of jack adapters. Each jack adapter is specifically designed to attach to a particular type of car jack, thus providing an apparatus that may be utilized with an assortment of car jacks.

It is apparent that numerous innovations for motor-driven jacks have been provided in the prior art, which are adapted to be used. Furthermore, even though these innovations may be suitable for the specific individual purposes to which they address, nevertheless, they would not be suitable for the purposes of the embodiments of the present invention as heretofore described, namely, portable and self-contained prime mover arrangement for receiving, and thereby motorizing, a conventional and pre-existing mechanical bottle jack or a conventional pre-existing scissor jack and for being so stabilized and so balanced so as to be readily insertable under a vehicle requiring lifting off a generally horizontal surface while remaining in full contact with the generally horizontal surface during positioning under, and lifting or lowering, the vehicle.

### 2. SUMMARY OF THE INVENTION

Thus, an object of the embodiments of the present invention is to provide a portable and self-contained prime mover arrangement for receiving, and thereby motorizing, a conventional and pre-existing mechanical bottle jack or a conventional pre-existing scissor jack and for being so stabilized and so balanced so as to be readily insertable under a vehicle requiring lifting off a generally horizontal surface while remaining in full contact with the generally horizontal surface during positioning under, and lifting or lowering, the vehicle, which avoids the disadvantages of the prior art.

Briefly stated, another object of the embodiments of the present invention is to provide a portable and self-contained prime mover arrangement receiving, and thereby motorizing, either a conventional and pre-existing mechanical bottle jack or a conventional and pre-existing scissor jack and being so stabilized and so balanced so as to be readily insertable under a vehicle requiring lifting off a generally horizontal surface while remaining in full contact with the generally horizontal surface during positioning under, and lifting or lowering, the vehicle. The arrangement includes a base, an electric motor, a gear box, a coupler, and a handle. The base is positioned on the generally horizontal surface and is so stabilized and so balanced so as to be readily insertable under the vehicle requiring lifting off the generally horizontal surface while remaining in full contact with the generally horizontal surface during positioning under, and lifting or lowering, the vehicle. The electric motor is positioned on the base. The gear box is positioned on the base and is operatively connected to the electric motor. The coupler is positioned on the base, is operatively connected to the gear box, receives, and thereby motorizes, either the conventional and pre-existing mechanical bottle jack or the conventional and pre-existing scissor jack. The handle is replaceably attached to the base and readily inserts the portable and self-contained prime mover arrangement under the vehicle or readily removes the portable and self-contained prime mover arrangement from under the vehicle.

The novel features considered characteristic of the embodiments of the present invention are set forth in the appended claims. The embodiments of the present invention themselves, however, both as to their construction and to their method of operation together with additional objects and advantages thereof will be best understood from the following description of the specific embodiments when read and understood in connection with the accompanying figures of the drawing.

### 3. BRIEF DESCRIPTION OF THE FIGURES OF THE DRAWING

The figures of the drawing are briefly described as follows:

FIG. 1 is a diagrammatic perspective view of a first embodiment of the portable and self-contained prime mover arrangement of the embodiments of the present invention receiving, and thereby motorizing, a conventional and pre-existing mechanical bottle jack;

FIG. 2 is a diagrammatic perspective view of the first embodiment of the portable and self-contained prime mover arrangement being so stabilized and so balanced so as to be readily insertable under a vehicle requiring lifting off a generally horizontal surface;

FIG. 3 is a diagrammatic perspective view of the first embodiment of the portable and self-contained prime mover arrangement remaining in full contact with the generally horizontal surface during positioning under, and lifting or lowering, the vehicle;

FIG. 4 is an enlarged diagrammatic perspective view of the first embodiment of the portable and self-contained prime mover arrangement identified by ARROW 4 in FIGS. 1-3;

FIG. 5 is a diagrammatic perspective view of a storage case that is closed and in which the first embodiment of the portable and self-contained prime mover arrangement is stored when not in use;

FIG. 6 is an enlarged diagrammatic perspective view of the area generally enclosed by the dotted circle identified by ARROW 6 in FIG. 5 of a zipper of the storage case of the first embodiment of the portable and self-contained prime mover arrangement;

FIG. 7 is a diagrammatic perspective view of the storage case shown in FIG. 5 that is partially opened and in which the first embodiment of the portable and self-contained prime mover arrangement has been removed for use;

FIG. 8 is a diagrammatic perspective view of the storage case shown in FIG. 7 that is completely opened wherein a portion thereof forms a kneeling pad for a user to kneel on when the first embodiment of the portable and self-contained prime mover arrangement has been removed and ready for use;

FIG. 8A is an enlarged diagrammatic cross sectional view taken along LINE 8A-8A in FIG. 7;

FIG. 8B is an enlarged diagrammatic cross sectional view taken along LINE 8B-8B in FIG. 8;

FIG. 9 is a diagrammatic side elevational view of an articulated handle of the first embodiment of the portable and self-contained prime mover arrangement identified by ARROW 9 in FIG. 4 in a folded state;

FIG. 10 is a diagrammatic side elevational view of one side of the articulated handle of the first embodiment of the portable and self-contained prime mover arrangement shown in FIG. 9 in an extended state;

FIG. 11 is a diagrammatic side elevational view of the other side of the articulated handle of the first embodiment of the portable and self-contained prime mover arrangement shown in FIG. 9 in an extended state;

FIG. 12 is an enlarged diagrammatic perspective view of the area generally enclosed by the dotted circle identified by ARROW 12 in FIG. 4 of a cigarette lighter plug adapter of the first embodiment of the portable and self-contained prime mover arrangement in the process of being inserted into a cigarette lighter of the vehicle;

FIG. 13 is an enlarged diagrammatic perspective view of the area generally enclosed by the dotted circle identified by ARROW 13 in FIG. 4 of a controller of the first embodiment of the portable and self-contained prime mover arrangement;

FIG. 14 is a diagrammatic perspective view of a second embodiment of the portable and self-contained prime mover arrangement of the embodiments of the present invention receiving, and thereby motorizing, a conventional pre-existing scissor jack;

FIG. 15 is a diagrammatic perspective view of the second embodiment of the portable and self-contained prime mover arrangement being so stabilized and so balanced so as to be readily insertable under a vehicle requiring lifting off a generally horizontal surface;

FIG. 16 is a diagrammatic perspective view of the second embodiment of the portable and self-contained prime mover arrangement remaining in full contact with the generally horizontal surface during positioning under, and lifting or lowering, the vehicle;

FIG. 17 is an enlarged diagrammatic perspective view of the second embodiment of the portable and self-contained prime mover arrangement identified by ARROW 17 in FIGS. 14-16;

FIG. 18 is an enlarged diagrammatic side elevational view taken generally in the direction of ARROW 18 in FIG. 17 of the scissor jack;

FIG. 18A is an enlarged diagrammatic perspective view of the area generally enclosed by the dotted curve identified by ARROW 18A in FIG. 17 of the articulated handle of the second embodiment of the portable and self-contained prime mover arrangement shown in FIG. 17 being used for pushing;

FIG. 18B is an enlarged diagrammatic perspective view of the area generally enclosed by the dotted curve identified by ARROW 18B in FIG. 17 of the articulated handle of the second embodiment of the portable and self-contained prime mover arrangement shown in FIG. 17 being used for pulling;

FIG. 19 is a diagrammatic perspective view of a storage case that is closed and in which the second embodiment of the portable and self-contained prime mover arrangement is stored when not in use;

FIG. 20 is an enlarged diagrammatic perspective view of the area generally enclosed by the dotted circle identified by ARROW 20 in FIG. 19 of a zipper of the storage case of the second embodiment of the portable and self-contained prime mover arrangement;

FIG. 21 is a diagrammatic perspective view of the storage case shown in FIG. 19 that is partially opened and in which the second embodiment of the portable and self-contained prime mover arrangement has been removed for use;

FIG. 22 is a diagrammatic perspective view of the storage case shown in FIG. 21 that is completely opened wherein a portion thereof forms a kneeling pad for a user to kneel on when the second embodiment of the portable and self-contained prime mover arrangement has been removed and ready for use;

FIG. 22A is an enlarged diagrammatic cross sectional view taken along LINE 22A-22A in FIG. 21;

FIG. 22B is an enlarged diagrammatic cross sectional view taken along LINE 22B-22B in FIG. 22; and

FIG. 23 is an enlarged diagrammatic perspective view of the area generally enclosed by the dotted circle identified by ARROW 23 in FIG. 17 of a cigarette lighter plug adapter of the second embodiment of the portable and self-contained prime mover arrangement in the process of being inserted into a cigarette lighter of the vehicle.

### 4. LIST OF REFERENCE NUMERALS UTILIZED IN THE FIGURES OF THE DRAWING

A. Introductory.
30 portable and self-contained prime mover arrangement of first embodiment of present invention for receiving, and thereby motorizing, conventional and pre-existing mechanical bottle jack 32 and for being so stabilized and so balanced so as to be readily insertable under vehicle 34 requiring lifting off generally horizontal surface 36 while remaining in full contact with generally horizontal surface 36 during positioning under, and lifting or lowering, vehicle 34
32 conventional and pre-existing mechanical bottle jack
33 base of conventional and pre-existing mechanical bottle jack 32
34 vehicle
36 generally horizontal surface

B. Overall Configuration of First Embodiment of Portable and Self-Contained Prime Mover Arrangement 30.
38 base for being positioned on generally horizontal surface 36 and for being so stabilized and so balanced so as to be readily insertable under vehicle 34 requiring lifting off generally horizontal surface 36 while remaining in full contact with generally horizontal surface 36 during positioning under, and lifting or lowering, vehicle 34
40 electric motor
42 gear box
44 coupler for receiving, and thereby motorizing, conventional and pre-existing mechanical bottle jack 32
45 controller
46 handle for readily inserting portable and self-contained prime mover arrangement 30 under vehicle 34 or for readily removing portable and self-contained prime mover arrangement 30 from under vehicle 34
47 power source interface

C. Specific Configuration of Base 38, Electric Motor 40, Gear Box 42, and Coupler 44.

(1) Base 38.
48 plate of base 38
50 four-sided periphery of plate 48 of base 38
52 through slot 50 of plate 48 of base 38
54 one side of four-sided periphery 50 of plate 48 of base 38
55 opening in one side 54 of four-sided periphery 50 of plate 48 of base 38
56 opposite side of four-sided periphery 50 of plate 48 of base 38
58 remaining two sides of four-sided periphery 50 of plate 48 of base 38
59 ⅛″ high density polyurethane plastic plate of plate 48 of base 38
60 wall of base 38 for raising plate 48 of base 38 off generally horizontal surface 36
62 pair of inverted and opposing shoulders of wall 60 of base 38

(2) Electric Motor 40.
64 12 volt D.C. fractional horsepower electric motor of electric motor 40

(3) Gear Box 42.
66 right angle reducing gear box of gear box 42

(4) Coupler 44.
68 nylon/plastic insert adapting coupler of coupler 44
70 male drive pin of nylon/plastic insert adapting coupler 68 of coupler 44
72 cup-aluminum shaft adapter of nylon/plastic insert adapting coupler 68 of coupler 44
74 drive slot of conventional and pre-existing mechanical bottle jack 32

D. Specific Configuration of Handle 46.
76 double-notched clip of handle 46
78 folding rod of handle 46
80 plurality of sections of folding rod 78 of handle 46
82 hinges of folding rod 78 of handle 46
84 proximal end of folding rod 78 of handle 46
86 distal end of folding rod 78 of handle 46
88 hand grip of proximal end 84 of folding rod 78 of handle 46
90 pair of aligned pins of distal end 86 of folding rod 78 of handle 46

E. Specific Configuration of Power Source Interface 47.
92 12 volt cigarette lighter plug adapter of power source interface 47 for selectively engaging in cigarette lighter port 96 of vehicle 34
94 power cable of power source interface 47
96 cigarette lighter port of vehicle 34

F. Specific Configuration of Controller 45.
98 handheld two button key pad of controller 45 for selectively raising and lowering vehicle 34
100 control cable of controller 45
102 up button of handheld two button key pad 98 of controller 45
104 down button of handheld two button key pad 98 of controller 45

G. Specific Configuration of Storage Case 106.
106 storage case
108 receptacle portion of storage case 106
110 lid of storage case 106
112 hinge of storage case 106
114 zipper of storage case 106
116 fold-out panel of lid 110 of storage case 106
120 cushioned kneeling pad of storage case 106

H. Alternate Embodiment of Portable and Self-Contained Prime Mover Arrangement 230—Introductory.
230 portable and self-contained prime mover arrangement of second embodiment of present invention for receiving, and thereby motorizing, conventional and pre-existing scissor jack 232 having base 233 and for being so stabilized and so balanced so as to be readily insertable under vehicle 234 requiring lifting off generally horizontal surface 236 while remaining in full contact with generally horizontal surface 236 during positioning under, and lifting or lowering, vehicle 234
232 conventional and pre-existing scissor jack
233 base of conventional and pre-existing scissor jack 232
234 vehicle
236 generally horizontal surface

I. Overall Configuration of Second Embodiment of Portable and Self-Contained Prime Mover Arrangement 230.
238 base for being positioned on generally horizontal surface 236 and for being so stabilized and so balanced so as to be readily insertable under vehicle 234 requiring lifting off generally horizontal surface 236 while remaining in full contact with generally horizontal surface 236 during positioning under, and lifting or lowering, vehicle 234
240 electric motor
242 gear box
244 coupler for receiving, and thereby motorizing, conventional and pre-existing scissor jack 232
245 controller
246 handle for readily inserting portable and self-contained prime mover arrangement 230 under vehicle 234 or for removing portable and self-contained prime mover arrangement 230 from under vehicle 234
247 power source interface

J. Specific Configuration of Base 238, Electric Motor 240, Gear Box 242, and Coupler 244.

(1) Base 238.
248 plate of base 238
250 four-sided periphery of plate 248 of base 238
252 through slot 250 of plate 248 of base 238
254 one side of four-sided periphery 250 of plate 248 of base 238
255 opening in one side 254 of four-sided periphery 250 of plate 248 of base 238
256 opposite side of four-sided periphery 250 of plate 248 of base 238
258 remaining two sides of four-sided periphery 250 of plate 248 of base 238
259 ⅛″ high density polyurethane plastic plate of plate 248 of base 238
260 wall of base 238 for raising plate 248 of base 238 off generally horizontal surface 236
262 pair of inverted and opposing shoulders 262 of wall 260 of base 238

(2) Electric Motor 240.
264 12 volt D.C. fractional horsepower electric motor of electric motor 240

(3) Gear Box 242.
266 right angle reducing gear box of gear box 242

(4) Coupler 244.
268 nylon/plastic insert adapting coupler of coupler 244
270 female drive bore of nylon/plastic insert adapting coupler 268 of coupler 244
274 drive pin of conventional and pre-existing scissor jack 232

K. Specific Configuration of Handle 246.
276 double-notched clip of handle 246
278 folding rod of handle 246
280 plurality of sections of folding rod 278 of handle 246
282 hinges of plurality of sections 280 of folding rod 278 of handle 246
284 proximal end of folding rod 278 of handle 246
286 distal end of folding rod 278 of handle 246
288 hand grip of proximal end 284 of folding rod 278 of handle 246
290 pair of aligned pins of distal end 286 of folding rod 278 of handle 246

L. Specific Configuration of Power Source Interface 247.
292 12 volt cigarette lighter plug adapter of power source interface 247 for selectively engaging in cigarette lighter port 296 of vehicle 234
294 power cable of power source interface 247
296 cigarette lighter port of vehicle 234

M. Specific Configuration of Controller 245.
298 handheld two button key pad of controller 245 for selectively raising and lowering vehicle 234
300 control cable of controller 245
302 up button of handheld two button key pad 298 of controller 245
304 down button of handheld two button key pad 298 of controller 245

N. Specific Configuration of Storage Case 306.
306 storage case
308 receptacle portion of storage case 306
310 lid of storage case 306
312 hinge of storage case 306
314 zipper of storage case 306
316 fold-out panel of lid 310 of storage case 306
320 cushioned kneeling pad of storage case 306

### 5. DETAILED DESCRIPTION OF THE PREFERRED EMBODIMENTS

A. Introductory.

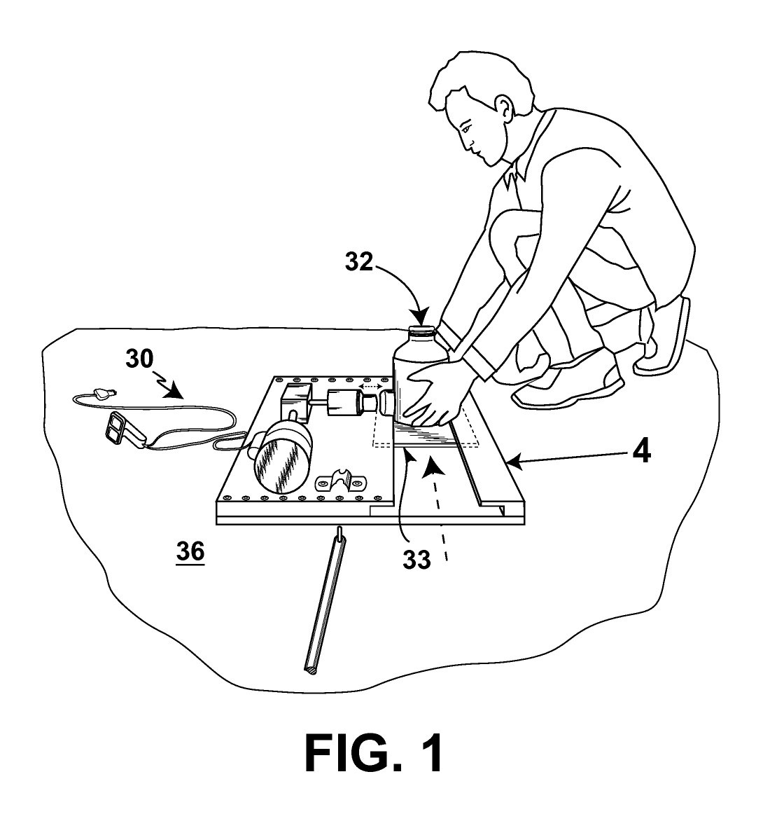

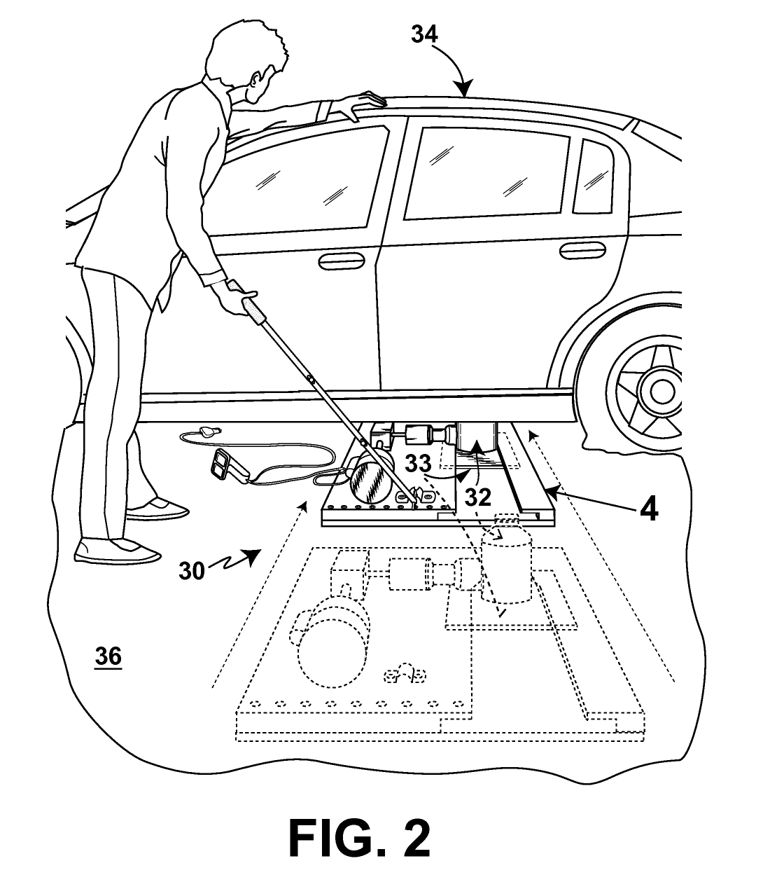

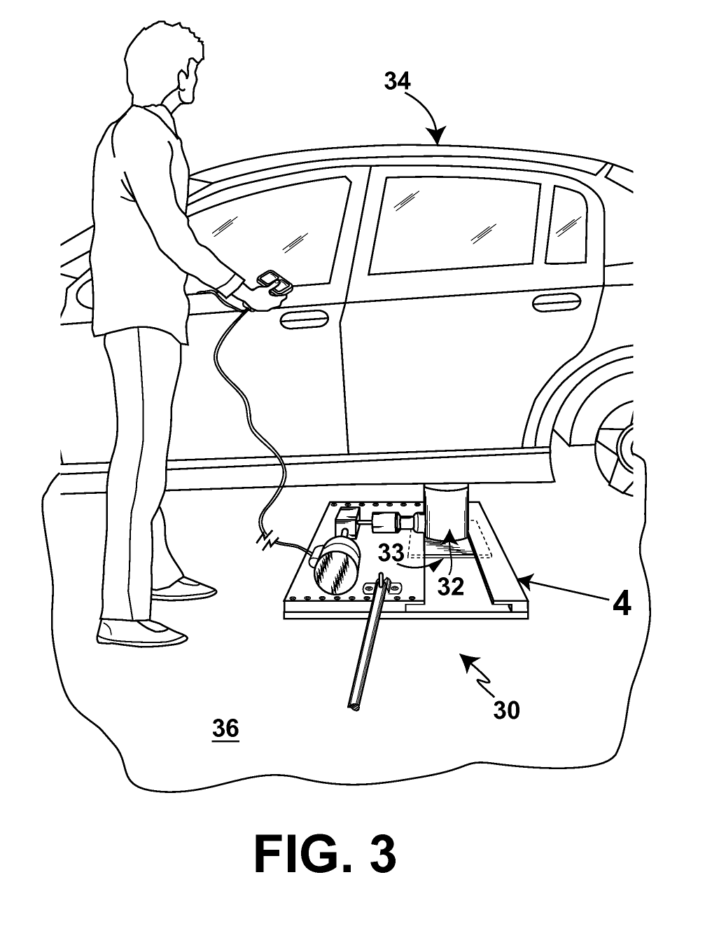

Referring now to the figures, in which like numerals indicate like parts, and particularly to FIGS. 1-3, which are, respectively, a diagrammatic perspective view of a first embodiment of the portable and self-contained prime mover arrangement of the embodiments of the present invention receiving, and thereby motorizing, a conventional and pre-existing mechanical bottle jack, diagrammatic perspective view of the first embodiment of the portable and self-contained prime mover arrangement being so stabilized and so balanced so as to be readily insertable under a vehicle requiring lifting off a generally horizontal surface, and a diagrammatic perspective view of the first embodiment of the portable and self-contained prime mover arrangement remaining in full contact with the generally horizontal surface during positioning under, and lifting or lowering, the vehicle, the portable and self-contained prime mover arrangement of a first embodiment of the present invention is shown generally at 30 for receiving, and thereby motorizing, a conventional and pre-existing mechanical bottle jack 32 having a base 33 (FIG. 1) and for being so stabilized and so balanced so as to be readily insertable under a vehicle 34 requiring lifting off a generally horizontal surface 36 (FIG. 2) while remaining in full contact with the generally horizontal surface 36 during positioning under (FIG. 2), and lifting or lowering (FIG. 3), the vehicle 34.

B. Overall Configuration of a First Embodiment of the Portable and Self-Contained Prime Mover Arrangement 30.

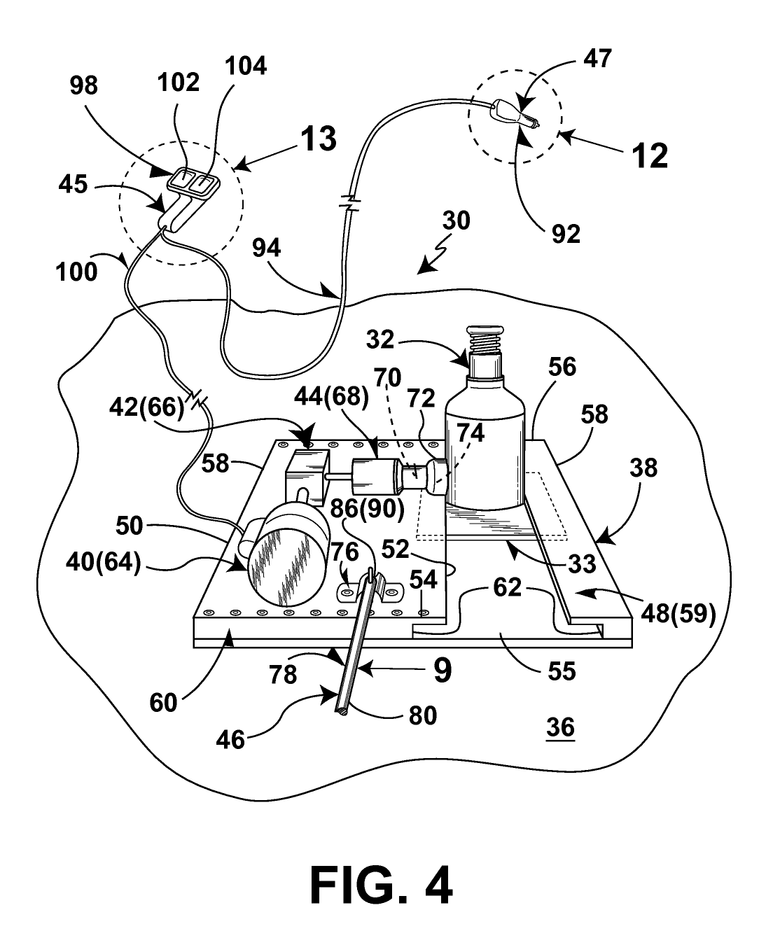

The overall configuration of a first embodiment of the portable and self-contained prime mover arrangement 30 can best bee seen in FIG. 4, which is an enlarged diagrammatic perspective view of the first embodiment of the portable and self-contained prime mover arrangement identified by ARROW 4 in FIGS. 1-3, and as such, will be discussed with reference thereto.

The portable and self-contained prime mover arrangement 30 comprises a base 38, an electric motor 40, a gear box 42, a coupler 44, and a handle 46.

The base 38 is for being positioned on the generally horizontal surface 36 and for being so stabilized and so balanced so as to be readily insertable under the vehicle 34 requiring lifting off the generally horizontal surface 36 while remaining in full contact with the generally horizontal surface 36 during positioning under, and lifting or lowering, the vehicle 34. The electric motor 40 is positioned on the base 38. The gear box 42 is positioned on the base 38, and is operatively connected to the electric motor 40. The coupler 44 is positioned on the base 38, is operatively connected to the gear box 42, and is for receiving, and thereby motorizing, the conventional and pre-existing mechanical bottle jack 32. The handle 46 is replaceably attached to the base 38, and is for readily inserting the portable and self-contained prime mover arrangement 30 under the vehicle 34 or for removing the portable and self-contained prime mover arrangement 30 from under the vehicle 34.

The portable and self-contained prime mover arrangement 30 further comprises a controller 45 and a power source interface 47.

The controller 45 is in electrical communication with, and controls direction of rotation of, the electric motor 40.

The power source interface 47 is in electrical communication with the controller 45 and a power source to power the electric motor 40.

C. Specific Configuration of the Base 38, the Electric Motor 40, the Gear Box 42, and the Coupler 44.

The specific configuration of the base 38, the electric motor 40, the gear box 42, and the coupler 44 can best be seen in FIG. 4, which is again an enlarged diagrammatic perspective view of the first embodiment of the portable and self-contained prime mover arrangement identified by ARROW 4 in FIGS. 1-3, and as such, will be discussed with reference thereto.

(1) The Base 38.

The base 38 comprises a plate 48. The plate 48 of the base 38 is generally rectangular-shaped, and as such, has a four-sided periphery 50.

The plate 48 of the base 38 further has a through slot 52. The through slot 50 of the plate 48 of the base 38 is generally rectangular-shaped, and extends from, and opens into, one side 54 of the four-sided periphery 50 of the plate 48 of the base 38, so as to provide an opening 55 in the one side 54 of the four-sided periphery 50 of the plate 48 of the base 38, to short of an opposite side 56 of the four-sided periphery 50 of the plate 48 of the base 38, and is generally parallel to a remaining two sides 58 of the four-sided periphery 50 of the plate 48 of the base 38.

The plate 48 of the base 38 is a ⅛″ high density polyurethane plastic plate 59.

The base 38 further comprises a wall 60. The wall 60 of the base 38 depends from the four-sided periphery 50 of the plate 48 of the base 38, except at the opening 55 in the one side 54 of the four-sided periphery 50 of the plate 48 of the base 38, and is for raising the plate 48 of the base 38 off the generally horizontal surface 36.

The wall 60 of the base 38 has a pair of inverted and opposing shoulders 62. The pair of inverted and opposing shoulders 62 of the wall 60 of the base 38 extend along the through slot 50 of the plate 48 of the base 38, and define the opening 55 in the one side 54 of the four-sided periphery 50 of the plate 48 of the base 38, so as to allow the conventional and pre-existing mechanical bottle jack 32 to be slid into the through slot 50 of the plate 48 of the base 38, with the base 33 of the conventional and pre-existing mechanical bottle jack 32 being captured by the pair of inverted and opposing shoulders 62 of the wall 60 of the base 38.

(2) The Electric Motor 40.

The electric motor 40 is a 12 volt D.C. fractional horsepower electric motor 64.

(3) The Gear Box 42.

The gear box 42 is a right angle reducing gear box 66.

(4) The Coupler 44.

The coupler 44 is a nylon/plastic insert adapting coupler 68. The nylon/plastic insert adapting coupler 68 of the coupler 44 has a male drive pin 70. The male drive pin 70 of the nylon/plastic insert adapting coupler 68 of the coupler 44 extends through a cup-aluminum shaft adapter 72, engages in, and rotates with, a drive slot 74 of the conventional and pre-existing mechanical bottle jack 32.

D. Specific Configuration of the Handle 46.

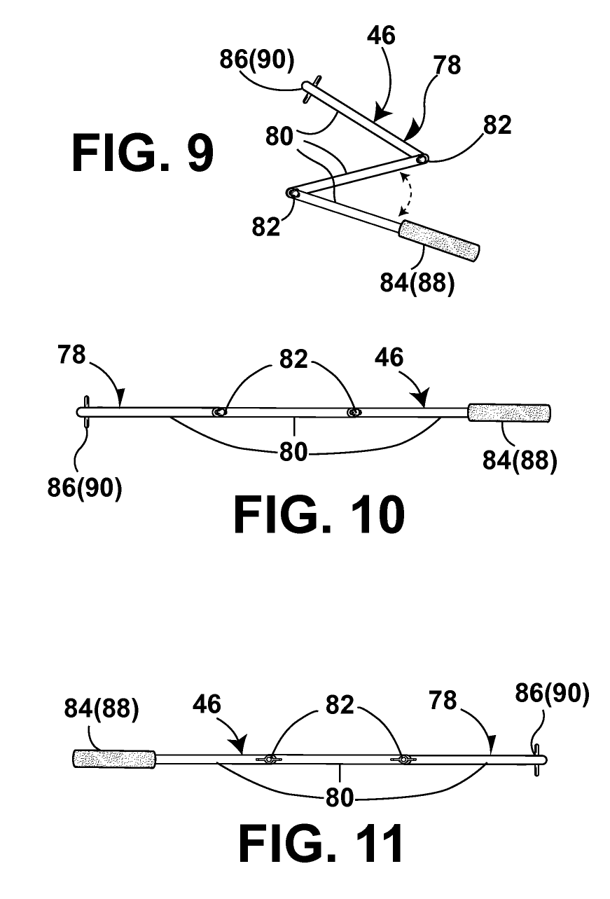

The specific configuration of the handle 46 can best be seen in FIGS. 4 and 9-11, which are, respectively, again an enlarged diagrammatic perspective view of the first embodiment of the portable and self-contained prime mover arrangement identified by ARROW 4 in FIGS. 1-3, a diagrammatic side elevational view of an articulated handle of the first embodiment of the portable and self-contained prime mover arrangement identified by ARROW 9 in FIG. 4 in a folded state, a diagrammatic side elevational view of one side of the articulated handle of the first embodiment of the portable and self-contained prime mover arrangement shown in FIG. 9 in an extended state, and a diagrammatic side elevational view of the other side of the articulated handle of the first embodiment of the portable and self-contained prime mover arrangement shown in FIG. 9 in an extended state, and as such, will be discussed with reference thereto.

The handle 46 comprises a double-notched clip 76. The double-notched clip 76 of the handle 46 is mounted to the plate 48 of the base 38, in proximity to the opening 55 of the one side 54 of the four-sided periphery 50 of the plate 48 of the base 38.

The handle 46 further comprises a folding rod 78. The folding rod 78 of the handle 46 is slender, elongated, and comprises a plurality of sections 80. The plurality of sections 80 of the folding rod 78 of the handle 46 are hingedly attached to each other end-to-end by hinges 82.

The folding rod 78 of the handle 46 has a proximal end 84 and a distal end 86. The proximal end 84 of the folding rod 78 of the handle 46 has a hand grip 88 thereon, while the distal end 86 of the folding rod 78 of the handle 46 has a pair of aligned pins 90 extending perpendicularly outwardly from opposing sides thereof.

The pair of aligned pins 90 of the distal end 86 of the folding rod 78 of the handle 46 selectively engage in a respective notch of the double-notched clip 76 of the handle 46, depending upon if the folding rod 78 of the handle 46 is to push the portable and self-contained prime mover arrangement 30 under the vehicle 34 or to pull the portable and self-contained prime mover arrangement 30 out from under the vehicle 34.

E. Specific Configuration of the Power Source Interface 47.

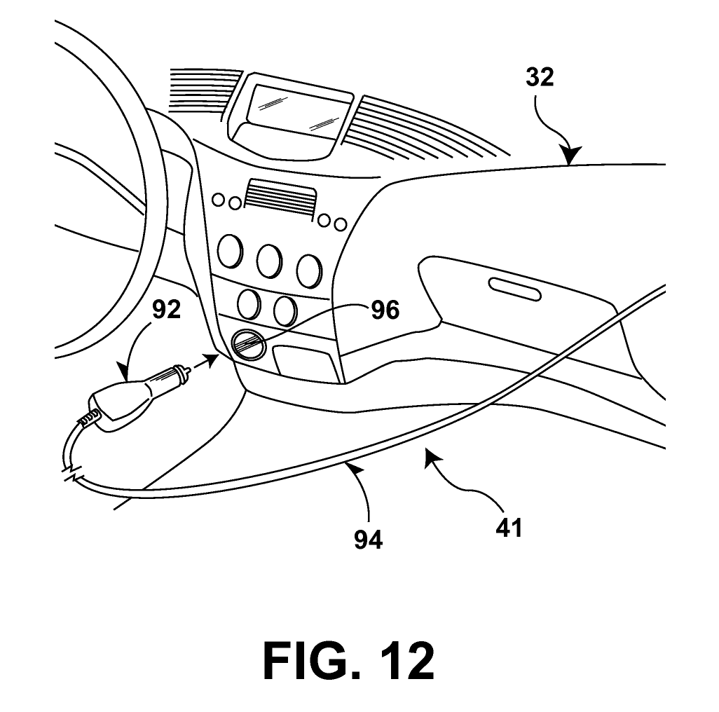

The specific configuration of the power source interface 47 can best be seen in FIGS. 4 and 12, which are, respectively, again an enlarged diagrammatic perspective view of the first embodiment of the portable and self-contained prime mover arrangement identified by ARROW 4 in FIGS. 1-3, and an enlarged diagrammatic perspective view of the area generally enclosed by the dotted circle identified by ARROW 12 in FIG. 4 of a cigarette lighter plug adapter of the first embodiment of the portable and self-contained prime mover arrangement in the process of being inserted into a cigarette lighter of the vehicle, and as such, will be discussed with reference thereto.

The power source interface 47 comprises a 12 volt cigarette lighter plug adapter 92 and a power cable 94. The 12 volt cigarette lighter plug adapter 92 of the power source interface 47 is in electrical communication with the controller 45 via the power cable 94 of the power source interface 47, and is for selectively engaging in a cigarette lighter port 96 of the vehicle 34.

F. Specific Configuration of the Controller 45.

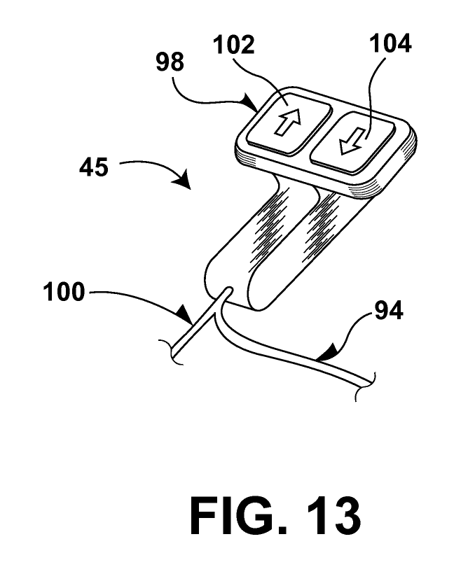

The specific configuration of the controller 45 can best be seen in FIGS. 4 and 13, which are, respectively, again an enlarged diagrammatic perspective view of the first embodiment of the portable and self-contained prime mover arrangement identified by ARROW 4 in FIGS. 1-3, and an enlarged diagrammatic perspective view of the area generally enclosed by the dotted circle identified by ARROW 13 in FIG. 4 of a controller of the first embodiment of the portable and self-contained prime mover arrangement, and as such, will be discussed with reference thereto.

The controller 45 comprises a handheld two button key pad 98 and a control cable 100. The handheld two button key pad 98 of the controller 45 comprises an up button 102 and a down button 104, is in electrical communication with the electric motor 40 via the control cable 100 of the controller 45, is in electrical communication with the 12 volt cigarette lighter plug adapter 92 of the power source interface 47 via the power cable 94 of the power source interface 45, and is for selectively raising and lowering the vehicle 34.

G. Specific Configuration of a Storage Case 106.

The portable and self-contained prime mover arrangement 30 further comprises a storage case 106.

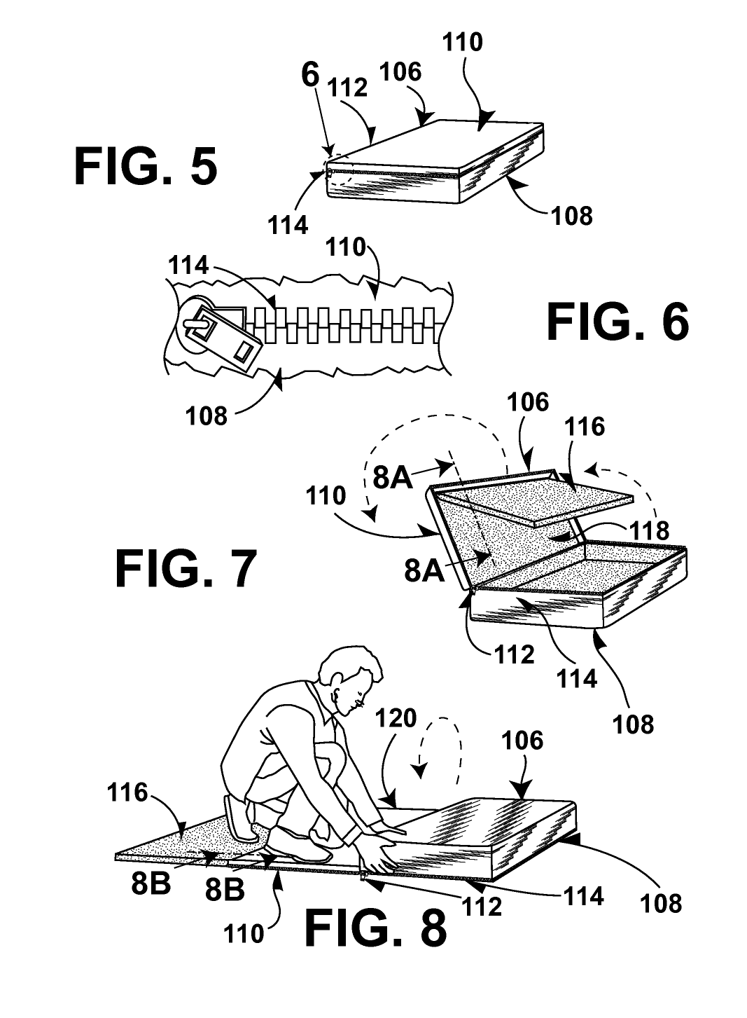

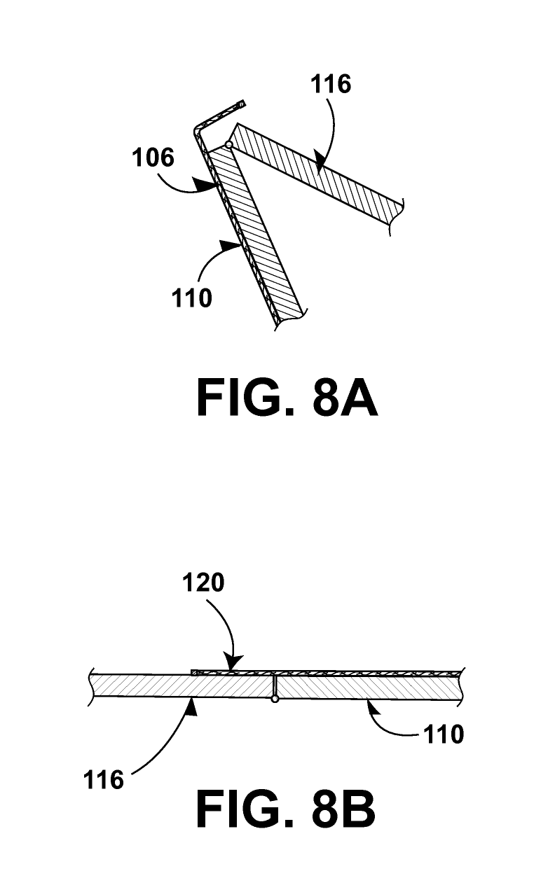

The specific configuration of the storage case 106 can best be seen in FIGS. 5, 6, 7, 8, 8A, and 8B, which are, respectively, a diagrammatic perspective view of a storage case that is closed and in which the first embodiment of the portable and self-contained prime mover arrangement is stored when not in use, an enlarged diagrammatic perspective view of the area generally enclosed by the dotted circle identified by ARROW 6 in FIG. 5 of a zipper of the storage case of the first embodiment of the portable and self-contained prime mover arrangement, a diagrammatic perspective view of the storage case shown in FIG. 5 that is partially opened and in which the first embodiment of the portable and self-contained prime mover arrangement has been removed for use, a diagrammatic perspective view of the storage case shown in FIG. 7 that is completely opened wherein a portion thereof forms a kneeling pad for a user to kneel on when the first embodiment of the portable and self-contained prime mover arrangement has been removed and ready for use, an enlarged diagrammatic cross sectional view taken along LINE 8A-8A in FIG. 7, and an enlarged diagrammatic cross sectional view taken along LINE 8B-8B in FIG. 8, and as such, will be discussed with reference thereto.

The storage case 106 is generally rectangular parallelepiped-shaped, and comprises a receptacle portion 108 and a lid 110.

The lid 110 of the storage case 106 is hingedly attached to the receptacle portion 108 of the storage case 106 by a hinge 112, and is selectively closed by a zipper 114.

The lid 110 of the storage case 106 comprises a fold-out panel 116. The fold-out panel 116 of the lid 110 of the storage case 106 is cushioned so when the receptacle portion 108 of the storage case 106 is turned up-side-down on the generally horizontal surface 36 and the fold-out panel 116 of the lid 110 of the storage case 106 is folded out of, and lies coplanarally with, the lid 110 of the storage case 106 on the generally horizontal surface 36, the fold-out panel 116 of the lid 110 of the storage case 106 and the lid 110 of the storage case 106 form a cushioned kneeling pad 120.

H. Alternate Embodiment of the Portable and Self-Contained Prime Mover Arrangement 230.

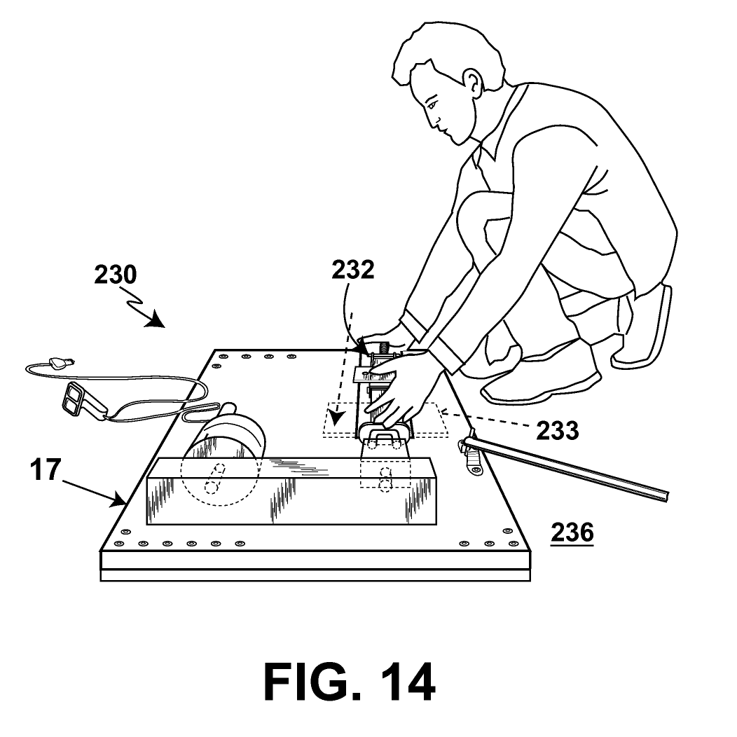

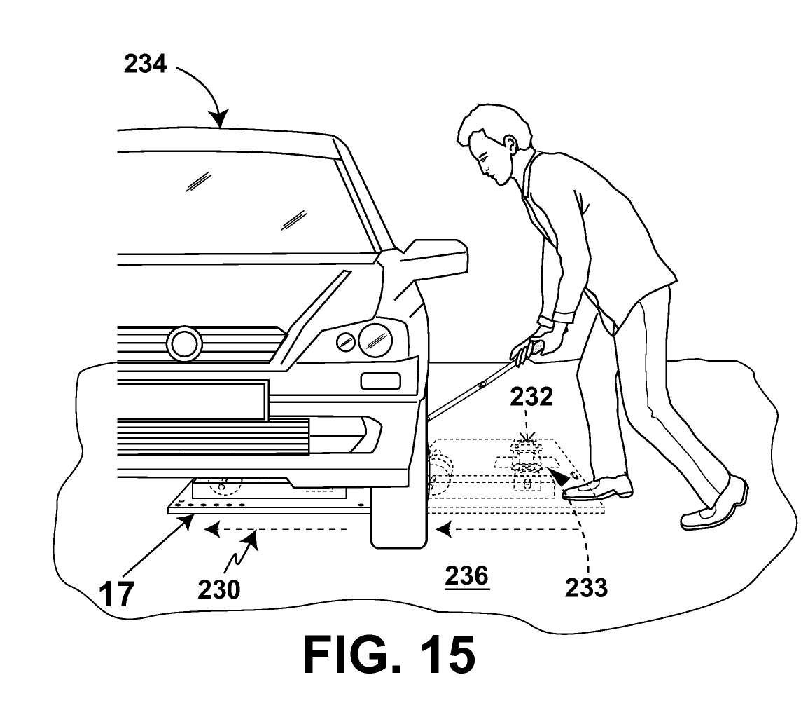

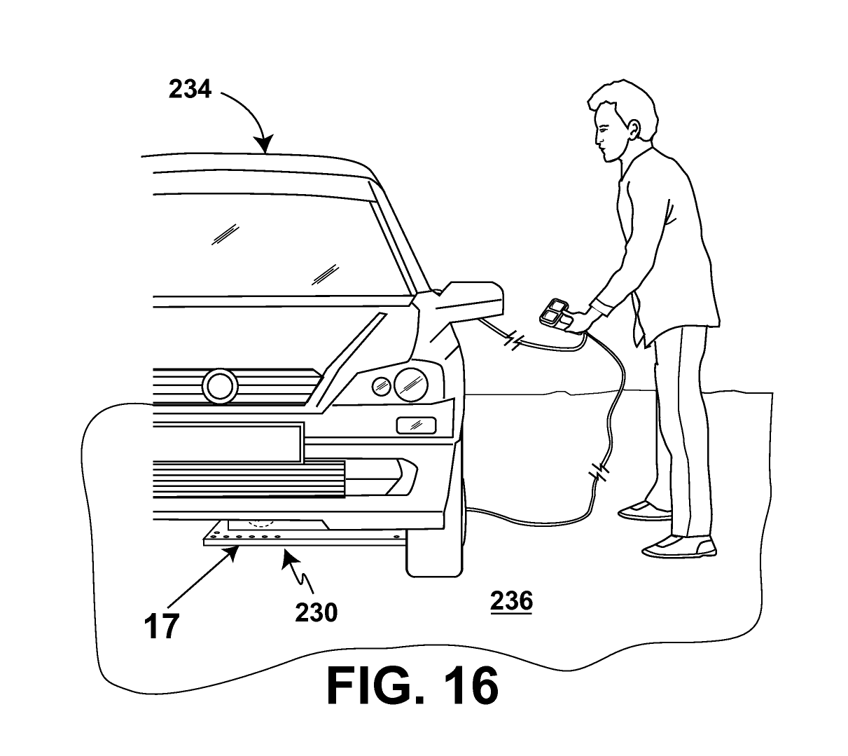

Referring now to FIGS. 14-16, which are, respectively, a diagrammatic perspective view of a second embodiment of the portable and self-contained prime mover arrangement of the embodiments of the present invention receiving, and thereby motorizing, a conventional and pre-existing scissor jack, a diagrammatic perspective view of the second embodiment of the portable and self-contained prime mover arrangement being so stabilized and so balanced so as to be readily insertable under a vehicle requiring lifting off a generally horizontal surface, and a diagrammatic perspective view of the second embodiment of the portable and self-contained prime mover arrangement remaining in full contact with the generally horizontal surface during positioning under, and lifting or lowering, the vehicle, the portable and self-contained prime mover arrangement of a second embodiment of the present invention is shown generally at 230 for receiving, and thereby motorizing, a conventional and pre-existing scissor jack 232 having a base 233 (FIG. 14) and for being so stabilized and so balanced so as to be readily insertable under a vehicle 234 requiring lifting off a generally horizontal surface 236 (FIG. 15) while remaining in full contact with the generally horizontal surface 236 during positioning under (FIG. 15), and lifting or lowering (FIG. 16), the vehicle 234.

I. Overall Configuration of the Second Embodiment of the Portable and Self-Contained Prime Mover Arrangement 230.

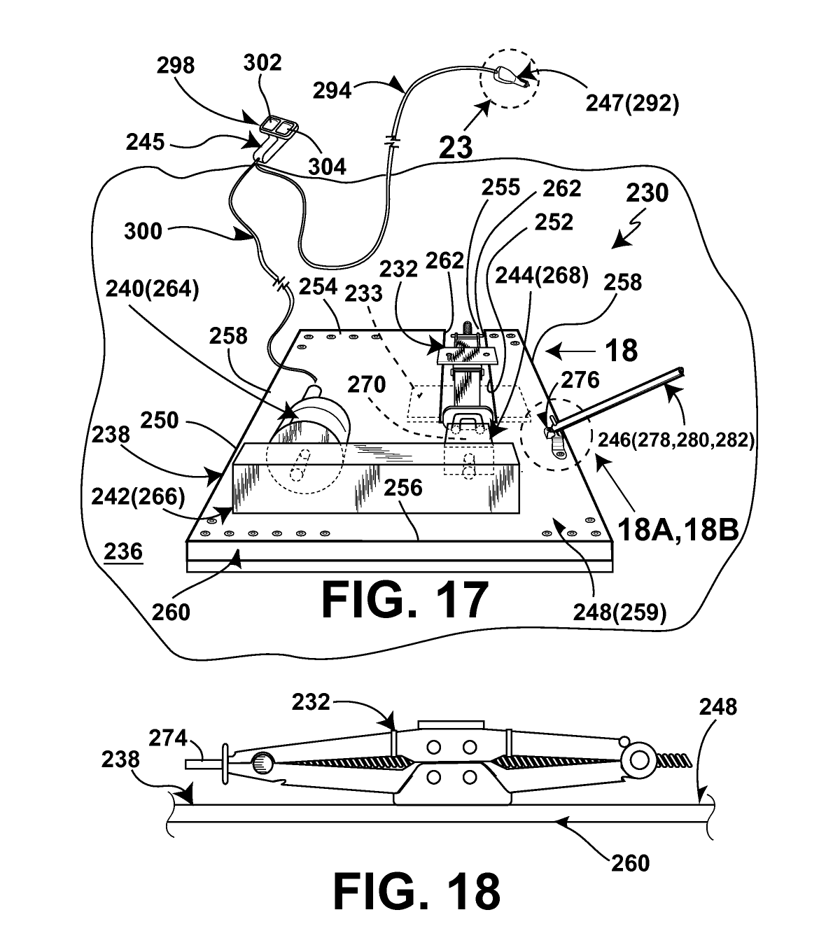

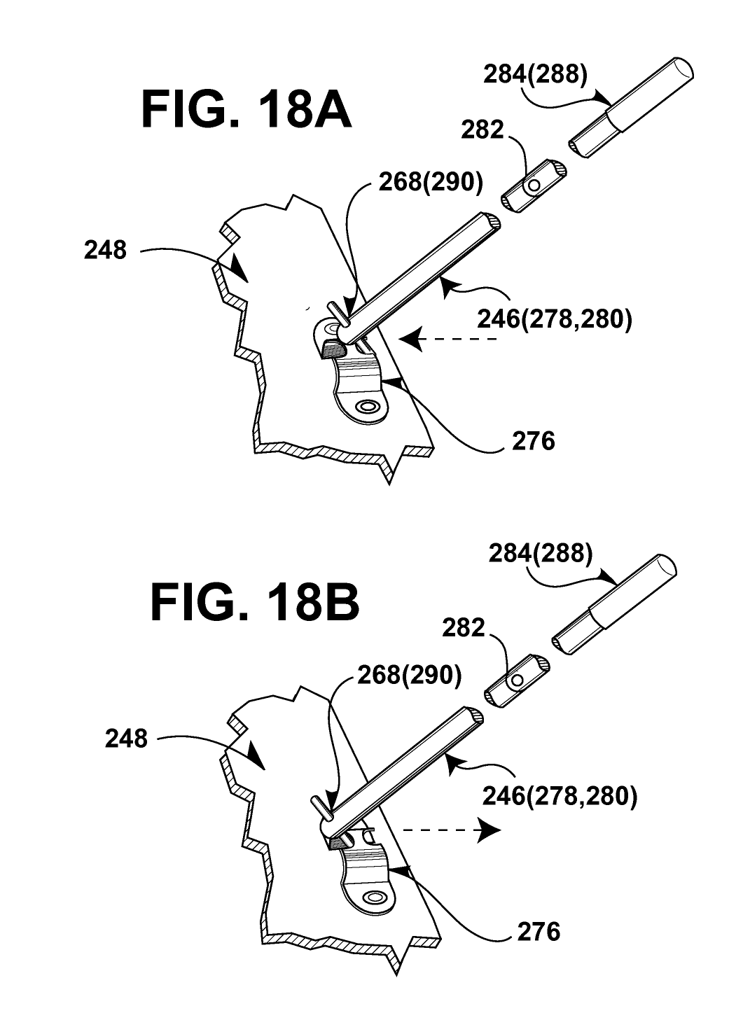

The overall configuration of the second embodiment of the portable and self-contained prime mover arrangement 230 can best bee seen in FIGS. 17 and 18, which are, respectively, an enlarged diagrammatic perspective view of the second embodiment of the portable and self-contained prime mover arrangement identified by ARROW 17 in FIGS. 14-16, and an enlarged diagrammatic side elevational view taken generally in the direction of ARROW 18 in FIG. 17 of the scissor jack, and as such, will be discussed with reference thereto.

The portable and self-contained prime mover arrangement 230 comprises a base 238, an electric motor 240, a gear box 242, a coupler 244, and a handle 246.

The base 238 is for being positioned on the generally horizontal surface 236 and for being so stabilized and so balanced so as to be readily insertable under the vehicle 234 requiring lifting off the generally horizontal surface 236 while remaining in full contact with the generally horizontal surface 236 during positioning under, and lifting or lowering, the vehicle 234. The electric motor 240 is positioned on the base 238. The gear box 242 is positioned on the base 238, and is operatively connected to the electric motor 240. The coupler 244 is positioned on the base 238, is operatively connected to the gear box 242, and is for receiving, and thereby motorizing, the conventional and pre-existing scissor jack 232. The handle 246 is replaceably attached to the base 238, and is for readily inserting the portable and self-contained prime mover arrangement 230 under the vehicle 234 or for removing the portable and self-contained prime mover arrangement 230 from under the vehicle 234.

The portable and self-contained prime mover arrangement 230 further comprises a controller 245 and a power source interface 247.

The controller 245 is in electrical communication with, and controls direction of rotation of, the electric motor 240.

The power source interface 247 is in electrical communication with the controller 245 and a power source to power the electric motor 240.

J. Specific Configuration of the Base 238, the Electric Motor 240, the Gear Box 242, and the Coupler 244.

The specific configuration of the base 238, the electric motor 240, the gear box 242, and the coupler 244 can best be seen in FIGS. 17 and 18, which are, respectively, again an enlarged diagrammatic perspective view of the second embodiment of the portable and self-contained prime mover arrangement identified by ARROW 17 in FIGS. 14-16, and an enlarged diagrammatic side elevational view taken generally in the direction of ARROW 18 in FIG. 17 of the scissor jack, and as such, will be discussed with reference thereto.

(1) The Base 238.

The base 238 comprises a plate 248. The plate 248 of the base 238 is generally rectangular-shaped, and as such, has a four-sided periphery 250.

The plate 248 of the base 238 further has a through slot 252. The through slot 250 of the plate 248 of the base 238 is generally rectangular-shaped, and extends from, and opens into, one side 254 of the four-sided periphery 250 of the plate 248 of the base 238, so as to provide an opening 255 in the one side 254 of the four-sided periphery 250 of the plate 248 of the base 238, to short of an opposite side 256 of the four-sided periphery 250 of the plate 248 of the base 238, and is generally parallel to a remaining two sides 258 of the four-sided periphery 250 of the plate 248 of the base 238.

The plate 248 of the base 238 is a ⅛″ high density polyurethane plastic plate 259.

The base 238 further comprises a wall 260. The wall 260 of the base 238 depends from the four-sided periphery 250 of the plate 248 of the base 238, except at the opening 255 in the one side 254 of the four-sided periphery 250 of the plate 248 of the base 238, and is for raising the plate 248 of the base 238 off the generally horizontal surface 236.

The wall 260 of the base 238 has a pair of inverted and opposing shoulders 262. The pair of inverted and opposing shoulders 262 of the wall 260 of the base 238 extend along the through slot 250 of the plate 248 of the base 238, and define the opening 255 in the one side 254 of the four-sided periphery 250 of the plate 248 of the base 238, so as to allow the conventional and pre-existing scissor jack 232 to be slid into the through slot 250 of the plate 248 of the base 238, with the base 233 of the conventional and pre-existing scissor jack 232 being captured by the pair of inverted and opposing shoulders 262 of the wall 260 of the base 238.

(2) The Electric Motor 240.

The electric motor 240 is a 12 volt D.C. fractional horsepower electric motor 264.

(3) The Gear Box 242.

The gear box 242 is a right angle reducing gear box 266.

(4) The Coupler 244.

The coupler 244 is a nylon/plastic insert adapting coupler 268. The nylon/plastic insert adapting coupler 268 of the coupler 244 has a female drive bore 270. The female drive bore 270 of the nylon/plastic insert adapting coupler 268 of the coupler 244 engages in, and rotates with, a drive pin 274 of the conventional and pre-existing scissor jack 232.

K. Specific Configuration of the Handle 246.

The specific configuration of the handle 246 can best be seen in FIGS. 17, 18A, and 18B, which are, respectively, again an enlarged diagrammatic perspective view of the second embodiment of the portable and self-contained prime mover arrangement identified by ARROW 17 in FIGS. 14-16, an enlarged diagrammatic perspective view of the area generally enclosed by the dotted curve identified by ARROW 18A in FIG. 17 of the articulated handle of the second embodiment of the portable and self-contained prime mover arrangement shown in FIG. 17 being used for pushing, and an enlarged diagrammatic perspective view of the area generally enclosed by the dotted curve identified by ARROW 18B in FIG. 17 of the articulated handle of the second embodiment of the portable and self-contained prime mover arrangement shown in FIG. 17 being used for pulling, and as such, will be discussed with reference thereto.

The handle 246 comprises a double-notched clip 276. The double-notched clip 276 of the handle 246 is mounted to the plate 248 of the base 238, in proximity to the opening 255 of the one side 254 of the four-sided periphery 250 of the plate 248 of the base 238.

The handle 246 further comprises a folding rod 278. The folding rod 278 of the handle 246 is slender, elongated, and comprises a plurality of sections 280. The plurality of sections 280 of the folding rod 278 of the handle 246 are hingedly attached to each other end-to-end by hinges 282.

The folding rod 278 of the handle 246 has a proximal end 284 and a distal end 286. The proximal end 284 of the folding rod 278 of the handle 246 has a hand grip 288 thereon, while the distal end 286 of the folding rod 278 of the handle 246 has a pair of aligned pins 290 extending perpendicularly outwardly from opposing sides thereof.

The pair of aligned pins 290 of the distal end 286 of the folding rod 278 of the handle 246 selectively engage in a respective notch of the double-notched clip 276 of the handle 246, depending upon if the folding rod 278 of the handle 246 is to push the portable and self-contained prime mover arrangement 230 under the vehicle 234 or to pull the portable and self-contained prime mover arrangement 230 out from under the vehicle 234.

L. Specific Configuration of the Power Source Interface 247.

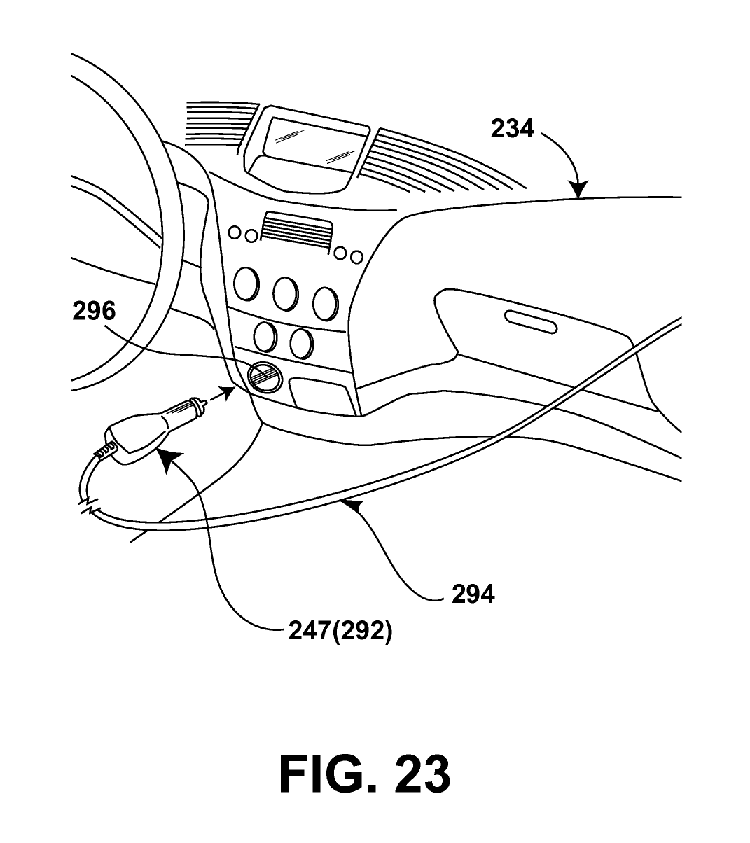

The specific configuration of the power source interface 247 can best be seen in FIGS. 17 and 23, which are, respectively, again an enlarged diagrammatic perspective view of the second embodiment of the portable and self-contained prime mover arrangement identified by ARROW 17 in FIGS. 14-16, and an enlarged diagrammatic perspective view of the area generally enclosed by the dotted circle identified by ARROW 23 in FIG. 17 of a cigarette lighter plug adapter of the second embodiment of the portable and self-contained prime mover arrangement in the process of being inserted into a cigarette lighter of the vehicle, and as such, will be discussed with reference thereto.

The power source interface 247 comprises a 12 volt cigarette lighter plug adapter 292 and a power cable 294. The 12 volt cigarette lighter plug adapter 292 of the power source interface 247 is in electrical communication with the controller 245 via the power cable 294 of the power source interface 247, and is for selectively engaging in a cigarette lighter port 296 of the vehicle 234.

M. Specific Configuration of the Controller 245.

The specific configuration of the controller 245 can best be seen in FIG. 17, which is again an enlarged diagrammatic perspective view of the second embodiment of the portable and self-contained prime mover arrangement identified by ARROW 17 in FIGS. 14-16, and as such, will be discussed with reference thereto.

The controller 245 comprises a handheld two button key pad 298 and a control cable 300. The handheld two button key pad 298 of the controller 245 comprises an up button 302 and a down button 304, is in electrical communication with the electric motor 240 via the control cable 300 of the controller 245, is in electrical communication with the 12 volt cigarette lighter plug adapter 292 of the power source interface 247 via the power cable 294 of the power source interface 247, and is for selectively raising and lowering the vehicle 234.

N. Specific Configuration of a Storage Case 306.

The portable and self-contained prime mover arrangement 230 further comprises a storage case 306.

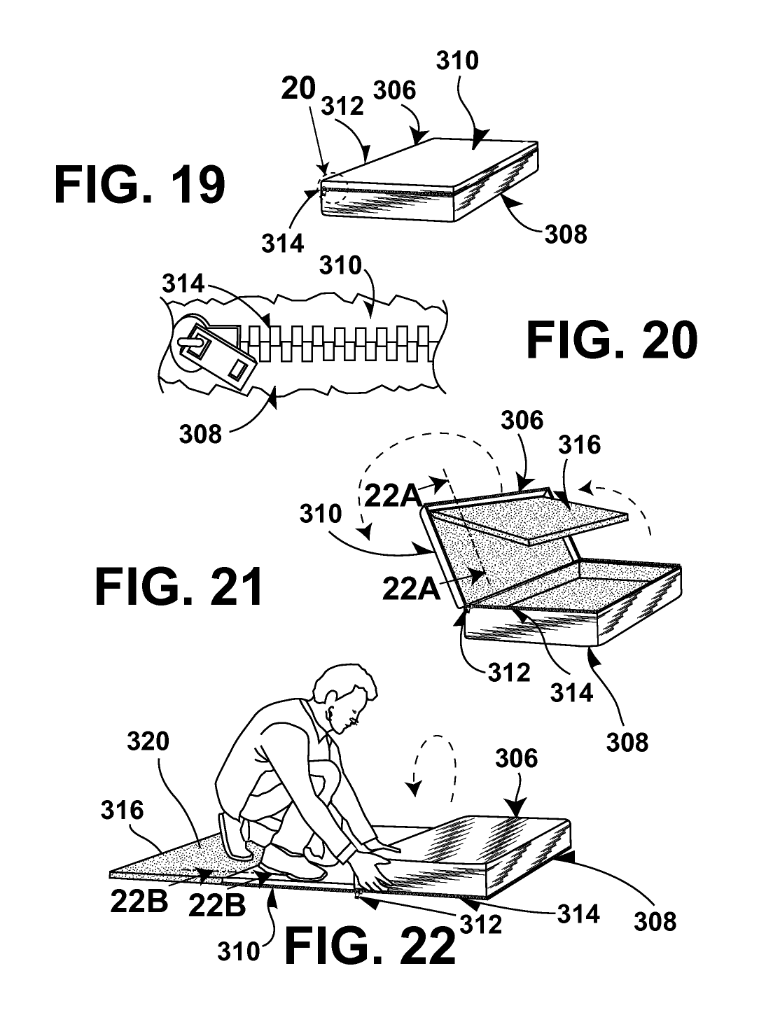

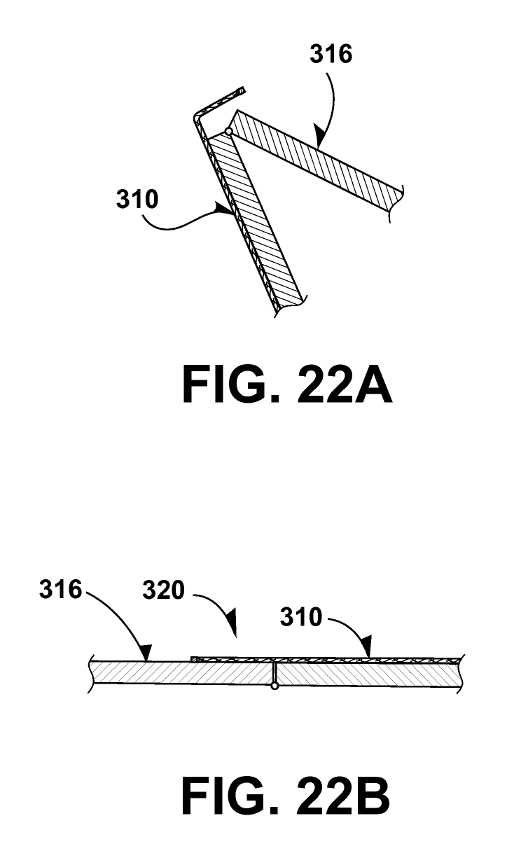

The specific configuration of the storage case 306 can best be seen in FIGS. 19, 20. 21, 22, 22A, and 22B, which are, respectively, a diagrammatic perspective view of a storage case that is closed and in which the second embodiment of the portable and self-contained prime mover arrangement is stored when not in use, an enlarged diagrammatic perspective view of the area generally enclosed by the dotted circle identified by ARROW 20 in FIG. 19 of a zipper of the storage case of the second embodiment of the portable and self-contained prime mover arrangement, a diagrammatic perspective view of the storage case shown in FIG. 19 that is partially opened and in which the second embodiment of the portable and self-contained prime mover arrangement has been removed for use, a diagrammatic perspective view of the storage case shown in FIG. 21 that is completely opened wherein a portion thereof forms a kneeling pad for a user to kneel on when the second embodiment of the portable and self-contained prime mover arrangement has been removed and ready for use, an enlarged diagrammatic cross sectional view taken along LINE 22A-22A in FIG. 21, and an enlarged diagrammatic cross sectional view taken along LINE 22B-22B in FIG. 22, and as such, will be discussed with reference thereto.

The storage case 306 is generally rectangular parallelepiped-shaped, and comprises a receptacle portion 308 and a lid 310.

The lid 310 of the storage case 306 is hingedly attached to the receptacle portion 308 of the storage case 306 by a hinge 312, and is selectively closed by a zipper 314.

The lid 310 of the storage case 306 comprises a fold-out panel 316. The fold-out panel 316 of the lid 310 of the storage case 306 is cushioned so when the receptacle portion 308 of the storage case 306 is turned up-side-down on the generally horizontal surface 236 and the fold-out panel 316 of the lid 310 of the storage case 306 is folded out of, and lies coplanarally with, the lid 310 of the storage case 306 on the generally horizontal surface 236, the fold-out panel 316 of the lid 310 of the storage case 306 and the lid 310 of the storage case 306 form a cushioned kneeling pad 320.

O. Impressions.

It will be understood that each of the elements described above or two or more together may also find a useful application in other types of constructions differing from the types described above.

While the embodiments of the present invention have been illustrated and described as embodied in a portable and self-contained prime mover arrangement for receiving, and thereby motorizing, a conventional and pre-existing mechanical bottle jack or a conventional and pre-existing scissor jack and for being so stabilized and so balanced so as to be readily insertable under a vehicle requiring lifting off a generally horizontal surface while remaining in full contact with the generally horizontal surface during positioning under, and lifting or lowering, the vehicle, however, they are not limited to the details shown, since it will be understood that various omissions, modifications, substitutions, and changes in the forms and details of the embodiments of the present invention illustrated and their operation can be made by those skilled in the art without departing in any way from the spirit of the embodiments of the present invention.

Without further analysis, the foregoing will so fully reveal the gist of the embodiments of the present invention that others can by applying current knowledge readily adapt them for various applications without omitting features that from the standpoint of prior art fairly constitute characteristics of the generic or specific aspects of the embodiments of the present invention.

1. A portable and self-contained prime mover arrangement for receiving, and thereby motorizing, a conventional and pre-existing mechanical bottle jack having a base and for being so stabilized and so balanced so as to be readily insertable under a vehicle requiring lifting off a generally horizontal surface while remaining in full contact with the generally horizontal surface during positioning under, and lifting or lowering, the vehicle, said arrangement comprising:
a) a base;
b) an electric motor;
c) a gear box;
d) a coupler; and
e) a handle;
wherein said base is for being positioned on the generally horizontal surface;
wherein said base is for being so stabilized and so balanced so as to be readily insertable under the vehicle requiring lifting off the generally horizontal surface while remaining in full contact with the generally horizontal surface during positioning under, and lifting or lowering, the vehicle;
wherein said electric motor is positioned on said base;
wherein said gear box is positioned on said base;
wherein said gear box is operatively connected to said electric motor;
wherein said coupler is positioned on said base;
wherein said coupler is operatively connected to said gear box;
wherein said coupler is for receiving, and thereby motorizing, the conventional and pre-existing mechanical bottle jack;
wherein said handle is replaceably attached to said base;
wherein said handle is for readily inserting said portable and self-contained prime mover arrangement under the vehicle or for removing said portable and self-contained prime mover arrangement from under the vehicle; and
wherein said gear box is a right angle reducing gear box.

2. The arrangement of claim 1, further comprising a controller.

3. The arrangement of claim 2, further comprising a power source interface.

4. The arrangement of claim 3, wherein said controller is in electrical communication with said electric motor; and
wherein said controller controls direction of rotation of said electric motor.

5. The arrangement of claim 4, wherein said power source interface is in electrical communication with said controller; and
wherein said power source interface is in electrical communication with a power source to power said electric motor.

6. The arrangement of claim 5, wherein said base comprises a plate.

7. The arrangement of claim 6, wherein said plate of said base is generally rectangular-shaped, and as such, has a four-sided periphery.

8. The arrangement of claim 7, wherein said plate of said base has a through slot.

9. The arrangement of claim 8, wherein said through slot of said plate of said base is generally rectangular-shaped;
wherein said through slot of said plate of said base extends from one side of said four-sided periphery of said plate of said base to short of an opposite side of said four-sided periphery of said plate of said base;
wherein said through slot of said plate of said base opens into said one side of said four-sided periphery of said plate of said base so as to provide an opening in said one side of said four-sided periphery of said plate of said base; and
wherein said through slot of said plate of said base is generally parallel to a remaining two sides of said four-sided periphery of said plate of said base.

10. The arrangement of claim 9, wherein said plate of said base is a ⅛″ high density polyurethane plastic plate.

11. The arrangement of claim 10, wherein said base comprises a wall.

12. The arrangement of claim 11, wherein said wall of said base depends from said four-sided periphery of said plate of said base, except at said opening in said one side of said four-sided periphery of said plate of said base; and
wherein said wall of said base is for raising said plate of said base off the generally horizontal surface.

13. The arrangement of claim 12, wherein said wall of said base has a pair of inverted and opposing shoulders.

14. The arrangement of claim 13, wherein said pair of inverted and opposing shoulders of said wall of said base extend along said through slot of said plate of said base; and
wherein said pair of inverted and opposing shoulders of said wall of said base define said opening in said one side of said four-sided periphery of said plate of said base so as to allow the conventional and pre-existing mechanical bottle jack to be slid into said through slot of said plate of said base, with the base of the conventional and pre-existing mechanical bottle jack captured by said pair of inverted and opposing shoulders of said wall of said base.

15. The arrangement of claim 14, wherein said electric motor is a 12 volt D.C. fractional horsepower electric motor.

16. (canceled)

17. The arrangement of claim 1, wherein said coupler is a nylon/plastic insert adapting coupler.

18. The arrangement of claim 17, wherein said nylon/plastic insert adapting coupler of said coupler has a male drive pin; and
wherein said male drive pin of said nylon/plastic insert adapting coupler of said coupler extends through a cup-aluminum shaft adapter, and engages in, and rotates with, a drive slot of the conventional and pre-existing mechanical bottle jack.

19. The arrangement of claim 18, wherein said handle comprises a double-notched clip.

20. The arrangement of claim 19, wherein said double-notched clip of said handle is mounted to said plate of said base; and
wherein said double-notched clip of said handle is disposed in proximity to said opening in said one side of said four-sided periphery of said plate of said base.

21. The arrangement of claim 20, wherein said handle comprises a folding rod.

22. The arrangement of claim 21, wherein said folding rod of said handle is slender;
wherein said folding rod of said handle is elongated; and
wherein said folding rod of said handle comprises a plurality of sections.

23. The arrangement of claim 22, wherein said plurality of sections of said folding rod of said handle are hingedly attached to each other end-to-end by hinges.

24. The arrangement of claim 23, wherein said folding rod of said handle has a proximal end;
wherein said proximal end of said folding rod of said handle has a hand grip thereon.

25. The arrangement of claim 24, wherein said folding rod of said handle has a distal end; and
wherein said distal end of said folding rod of said handle has a pair of aligned pins extending perpendicularly outwardly from opposing sides thereof.

26. The arrangement of claim 25, wherein said pair of aligned pins of said distal end of said folding rod of said handle selectively engage in a respective notch of said double-notched clip of said handle, depending upon if said folding rod of said handle is to push said portable and self-contained prime mover arrangement under the vehicle or to pull said portable and self-contained prime mover arrangement out from under the vehicle.

27. The arrangement of claim 26, wherein said power source interface comprises:
a) a 12 volt cigarette lighter plug adapter; and
b) a power cable.

28. The arrangement of claim 27, wherein said 12 volt cigarette lighter plug adapter of said power source interface is in electrical communication with said controller via said power cable of said power source interface; and
wherein said 12 volt cigarette lighter plug adapter of said power source interface is for selectively engaging in a cigarette lighter port of the vehicle.

29. The arrangement of claim 28, wherein said controller comprises:
a) a handheld two button key pad; and
b) a control cable.

30. The arrangement of claim 29, wherein said handheld two button key pad of said controller comprises:
a) an up button; and
b) a down button;
wherein said handheld two button key pad of said controller is in electrical communication with said electric motor via said control cable of said controller;
wherein said handheld two button key pad of said controller is in electrical communication with said 12 volt cigarette lighter plug adapter of said power source interface via said power cable of said power source interface; and
wherein said handheld two button key pad of said controller is for selectively raising and lowering the vehicle.

31. The arrangement of claim 30, further comprising a storage case.

32. The arrangement of claim 31, wherein said storage case is generally rectangular parallelepiped-shaped; and
wherein said storage case comprises:
a) a receptacle portion; and
b) a lid.

33. The arrangement of claim 32, wherein said lid of said storage case is hingedly attached to said receptacle portion of said storage case by a hinge; and
wherein said lid of said storage case is selectively closed by a zipper.

34. The arrangement of claim 33, wherein said lid of said storage case comprises a fold-out panel.

35. The arrangement of claim 34, wherein said fold-out panel of said lid of said storage case is cushioned by padded nylon so when said receptacle portion of said storage case is turned up-side-down on the generally horizontal surface and said fold-out panel of said lid of said storage case is folded out of and lies coplanarally with said lid of said storage case on the generally horizontal surface, said fold-out panel of said lid of said storage case and said lid of said storage case form a cushioned kneeling pad.

36. A portable and self-contained prime mover arrangement for receiving, and thereby motorizing, a conventional and pre-existing scissor jack having a base and for being so stabilized and so balanced so as to be readily insertable under a vehicle requiring lifting off a generally horizontal surface while remaining in full contact with the generally horizontal surface during positioning under, and lifting or lowering, the vehicle, said arrangement comprising:
a) a base;
b) an electric motor;
c) a gear box;
d) a coupler; and
e) a handle;
wherein said base is for being positioned on the generally horizontal surface;
wherein said base is for being so stabilized and so balanced so as to be readily insertable under the vehicle requiring lifting off the generally horizontal surface while remaining in full contact with the generally horizontal surface during positioning under, and lifting or lowering, the vehicle;
wherein said electric motor is positioned on said base;
wherein said gear box is positioned on said base;
wherein said gear box is operatively connected to said electric motor;
wherein said coupler is positioned on said base;
wherein said coupler is operatively connected to said gear box;
wherein said coupler is for receiving, and thereby motorizing, the conventional and pre-existing scissor jack;
wherein said handle is replaceably attached to said base;
wherein said handle is for readily inserting said portable and self-contained prime mover arrangement under the vehicle or for removing said portable and self-contained prime mover arrangement from under the vehicle; and
wherein said gear box is a right angle reducing gear box.

37. The arrangement of claim 36, further comprising:
a) a controller; and
b) a power source interface.

38. The arrangement of claim 37, wherein said controller is in electrical communication with said electric motor; and
wherein said controller controls direction of rotation of said electric motor.

39. The arrangement of claim 38, wherein said power source interface is in electrical communication with said controller and a power source to power said electric motor.

40. The arrangement of claim 39, wherein said base comprises a plate.

41. The arrangement of claim 40, wherein said plate of said base is generally rectangular-shaped, and as such, has a four-sided periphery.

42. The arrangement of claim 41, wherein said plate of said base has a through slot.

43. The arrangement of claim 42, wherein said through slot of said plate of said base is generally rectangular-shaped;
wherein said through slot of said plate of said base extends from, and opens into, one side of said four-sided periphery of said plate of said base, so as to provide an opening in said one side of said four-sided periphery of said plate of said base, to short of an opposite side of said four-sided periphery of said plate of said base; and
wherein said through slot of said plate of said base is generally parallel to a remaining two sides of said four-sided periphery of said plate of said base.

44. The arrangement of claim 43, wherein said plate of said base is a ⅛″ high density polyurethane plastic plate.

45. The arrangement of claim 44, wherein said base comprises a wall.

46. The arrangement of claim 45, wherein said wall of said base depends from said four-sided periphery of said plate of said base, except at said opening in said one side of said four-sided periphery of said plate of said base; and
wherein said wall of said base is for raising said plate of said base offthe generally horizontal surface.

47. The arrangement of claim 46, wherein said wall of said base has a pair of inverted and opposing shoulders.

48. The arrangement of claim 47, wherein said pair of inverted and opposing shoulders of said wall of said base extend along said through slot of said plate of said base; and
wherein said pair of inverted and opposing shoulders of said wall of said base define said opening in said one side of said four-sided periphery of said plate of said base, so as to allow the conventional and pre-existing scissor jack to be slid into said through slot of said plate of said base, with the base of said conventional and pre-existing scissor jack being captured by said pair of inverted and opposing shoulders of said wall of said base.

49. The arrangement of claim 48, wherein said electric motor is a 12 volt D.C. fractional horsepower electric motor.

50. (canceled)

51. The arrangement of claim 36, wherein said coupler is a nylon/plastic insert adapting coupler.

52. The arrangement of claim 51, wherein said nylon/plastic insert adapting coupler of said coupler has a female drive bore;
wherein said female drive bore of said nylon/plastic insert adapting coupler of said coupler engages in a drive pin of the conventional and pre-existing scissor jack; and
wherein said female drive bore of said nylon/plastic insert adapting coupler of said coupler rotates with a drive pin of the conventional and pre-existing scissor jack.

53. The arrangement of claim 52, wherein said handle comprises a double-notched clip.

54. The arrangement of claim 53, wherein said double-notched clip of said handle is mounted to said plate of said base; and
wherein said double-notched clip of said handle is disposed in proximity to said opening of said one side of said four-sided periphery of said plate of said base.

55. The arrangement of claim 54, wherein said handle comprises a folding rod.

56. The arrangement of claim 55, wherein said folding rod of said handle is slender;
wherein said folding rod of said handle is elongated; and
wherein said folding rod of said handle comprises a plurality of sections.

57. The arrangement of claim 56, wherein said plurality of sections of said folding rod of said handle are hingedly attached to each other end-to-end by hinges.

58. The arrangement of claim 57, wherein said folding rod of said handle has a proximal end; and
wherein said proximal end of said folding rod of said handle has a hand grip thereon.

59. The arrangement of claim 58, wherein said folding rod of said handle has a distal end; and
wherein said distal end of said folding rod of said handle has a pair of aligned pins extending perpendicularly outwardly from opposing sides thereof.

60. The arrangement of claim 59, wherein said pair of aligned pins of said distal end of said folding rod of said handle selectively engage in a respective notch of said double-notched clip of said handle, depending upon if said folding rod of said handle is to push said portable and self-contained prime mover arrangement under the vehicle or to pull said portable and self-contained prime mover arrangement out from under the vehicle.

61. The arrangement of claim 60, wherein said power source interface comprises:
a) a 12 volt cigarette lighter plug adapter; and
b) a power cable.

62. The arrangement of claim 61, wherein said 12 volt cigarette lighter plug adapter of said power source interface is in electrical communication with said controller via said power cable of said power source interface; and
wherein said 12 volt cigarette lighter plug adapter of said power source interface is for selectively engaging in a cigarette lighter port of the vehicle.

63. The arrangement of claim 62, wherein said controller comprises:
a) a handheld two button key pad; and
b) a control cable.

64. The arrangement of claim 63, wherein said handheld two button key pad of said controller comprises:
a) an up button; and
b) a down button;
wherein said handheld two button key pad of said controller is in electrical communication with said electric motor via said control cable of said controller;
wherein said handheld two button key pad of said controller is in electrical communication with said 12 volt cigarette lighter plug adapter of said power source interface via said power cable of said power source interface; and
wherein said handheld two button key pad of said controller is for selectively raising and lowering the vehicle.

65. The arrangement of claim 64, further comprising a storage case.

66. The arrangement of claim 65, wherein said storage case is generally rectangular parallelepiped-shaped; and
wherein said storage case comprises:
a) a receptacle portion; and
b) a lid.

67. The arrangement of claim 66, wherein said lid of said storage case is hingedly attached to said receptacle portion of said storage case by a hinge; and
wherein said lid of said storage case is selectively closed by a zipper.

68. The arrangement of claim 67, wherein said lid of said storage case comprises a fold-out panel.

69. The arrangement of claim 68, wherein said fold-out panel of said lid of said storage case is cushioned so when said receptacle portion of said storage case is turned up-side-down on the generally horizontal surface and said fold-out panel of said lid of said storage case is folded out of, and lies coplanarally with, said lid of said storage case on the generally horizontal surface, said fold-out panel of said lid of said storage case and said lid of said storage case form a cushioned kneeling pad.
